(19) United States
(12) Patent Application Publication
(10) Pub. No.: US 2010/0307358 A1
(43) Pub. Date: Dec. 9, 2010

(54) CLEANING DEVICE FOR SCREEN PRINTING MASK AND SCREEN PRINTING MACHINE

(75) Inventors: Takaaki Sakaue, Yamanashi (JP); Seiko Abe, Yamanashi (JP); Tetsuya Tanaka, Yamanashi (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/792,069

(22) Filed: Jun. 2, 2010

(30) Foreign Application Priority Data
Jun. 3, 2009 (JP) P2009-133653

(51) Int. Cl. B41F 35/00

(52) U.S. Cl. 101/425

(57) ABSTRACT

A cleaning device for a screen printing mask includes a paper member for rubbing a lower surface of a mask and a backup member for pressing the paper member against the lower surface of the mask via elastic members attached to an upper end portion thereof. As the backup member with the paper member pressed against the lower surface of the mask via the elastic members is relatively moved with respect to the mask, the paper member is served for rubbing the lower surface of the mask to thereby effect the wiping off of paste adhering to the lower surface of the mask.

### BACKGROUND OF THE INVENTION

1. Field of the Invention

The present invention relates to a cleaning device for a screen printing mask for effecting the wiping off of paste adhering to a lower surface of the screen printing mask and to a screen printing machine.

2. Related Art

In a screen printing mask (hereafter simply referred to as the mask) which is used in contact with a substrate at the time of printing paste such as solder paste on electrodes of the substrate, it is necessary to wipe off the paste left adhering to the mask after releasing so as to prepare for an ensuing screen printing process. In a cleaning device for effecting such wiping-off of the paste adhering to the mask, after a predetermined area (rubbing area) of a paper member placed on top of a backup member is pressed against the lower surface of the mask, the backup member is relatively moved with respect to the lower surface of the screen printing mask to rub the screen printing mask with the paper member, to thereby effect the wiping off of the paste adhering to the lower surface of the screen printing mask (e.g., JP-A-2004-66832). In addition, an upwardly closed air suction duct is provided inside the backup member, and this air suction duct is evacuated through the rubbing area of the paper member, thereby making it possible to suck out the paste adhering to the lower surface of the mask to the paper member side.

However, since the backup member provided in the cleaning device is formed of a metallic material such as aluminum, in cases where the lower surface of the mask (i.e., its surface with which the paper member is rubbed) does not have a flat shape, e.g., in cases where the screen printing mask of a relatively large size is deflected downward by its own weight and assumes a convex shape, there has been a problem in that an upper end portion of the backup member is unable to follow the shape of the mask and is hence unable to bring the paper member into close contact with the lower surface of the mask, causing in a decline in the efficiency of wiping off the paste. In addition, since the paper member cannot be brought into close contact with the lower surface of the mask, there has been another problem in that the effect of sucking out the paste by the suction of air can possibly decline disadvantageously.

### SUMMARY OF THE INVENTION

Accordingly, an object of the present invention is to provide a cleaning device for a screen printing mask and a screen printing machine which are capable of efficiently effecting the wiping off of paste with respect to the screen printing mask whose lower surface does not have a flat shape.

A cleaning device for a screen printing mask according to a first aspect of the invention is a cleaning device for a screen printing mask for effecting the wiping off of paste adhering to a lower surface of the screen printing mask, comprising: a paper member for rubbing a lower surface of the screen printing mask; a backup member for pressing the paper member against the lower surface of the screen printing mask via an elastic member attached to an upper end portion thereof; and a paper member rubbing device for effecting the wiping off of the paste adhering to the lower surface of the screen printing mask by rubbing the lower surface of the screen printing mask with the paper member by relatively moving with respect to the screen printing mask the backup member with the paper member pressed against the lower surface of the screen printing mask via the elastic member.

According to a second aspect of the invention, in the cleaning device for a screen printing mask according to the above-described first aspect of the invention, the elastic member attached to the upper end portion of the backup member is provided so as to surround an outer periphery of the upper end portion of the backup member.

According to a third aspect of the invention, in the cleaning device for a screen printing mask according to the above-described first or second aspect of the invention, the elastic member attached to the upper end portion of the backup member has a flatly formed surface of contact with the paper member.

A screen printing machine according to a fourth aspect of the invention is a screen printing machine for effecting screen printing on electrodes provided on a substrate, comprising: a screen printing mask which is used by coming into contact with the substrate and in which pattern holes corresponding to the electrodes on the substrate are formed; printing execution means for printing paste on the electrodes by supplying the paste onto the screen printing mask in a state in which the pattern holes formed in the screen printing mask and the electrodes on the substrate correspond to each other, and subsequently by relatively moving the screen printing mask and the substrate away from each other; and a cleaning device for the screen printing mask for effecting the wiping off of the paste adhering to the lower surface of the screen printing mask, the cleaning device for the screen printing mask including: a paper member for rubbing the lower surface of the screen printing mask; a backup member for pressing the paper member against the lower surface of the screen printing mask via an elastic member attached to an upper end portion thereof; and a paper member rubbing device for effecting the wiping off of the paste adhering to the lower surface of the screen printing mask by rubbing the lower surface of the screen printing mask with the paper member by relatively moving with respect to the screen printing mask the backup member with the paper member pressed against the lower surface of the screen printing mask via the elastic member.

In the invention, the arrangement provided is such that the paper member is pressed against the lower surface of the mask via the elastic member provided on the upper end portion of the backup member. Since the elastic member can be made to follow the shape of the screen printing mask by undergoing elastic deformation, even with the screen printing mask whose lower surface does not have a flat shape, the paper member can be brought into close contact with its lower surface, allowing the wiping off of the paste to be carried out efficiently. In addition, in cases where the paste adhering to the lower surface of the screen printing mask is adapted to be sucked out to the paper member side by sucking air through a rubbing area of the paper member from an air suction duct provided inside the backup member, the paper member can be brought into close contact with the lower surface of the mask. Therefore, the amount of air leakage during the suction of air becomes small, and it is hence possible to improve the effect of sucking out the paste, so that the efficiency of wiring off the paste can be improved in this aspect as well.

### BRIEF DESCRIPTION OF THE DRAWINGS

FIG. 1 is a schematic diagram of a screen printing machine in accordance with an embodiment of the invention;

FIG. 2A is a plan view of a substrate subject to printing by the screen printing machine in accordance with the embodiment of the invention;

FIG. 2B is a side cross-sectional view of the substrate shown in FIG. 2A;

FIG. 3A is a plan view of a mask provided in the screen printing machine in accordance with the embodiment of the invention;

FIG. 3B is a side cross-sectional view of the mask shown in FIG. 3A;

FIG. 4A is a partial perspective view of a cleaning device provided in the screen printing machine in accordance with the embodiment of the invention;

FIG. 4B is a cross-sectional view of the cleaning device shown in FIG. 4A;

FIGS. 5A and 5B are partial exploded perspective views of the cleaning device provided in the screen printing machine in accordance with the embodiment of the invention;

FIGS. 6A to 6D are diagrams explaining the operation of the screen printing machine in accordance with the embodiment of the invention; and

FIGS. 7A and 7B are diagrams explaining the operation of the cleaning device provided in the screen printing machine in accordance with the embodiment of the invention.

### DETAILED DESCRIPTION OF THE PREFERRED EMBODIMENTS

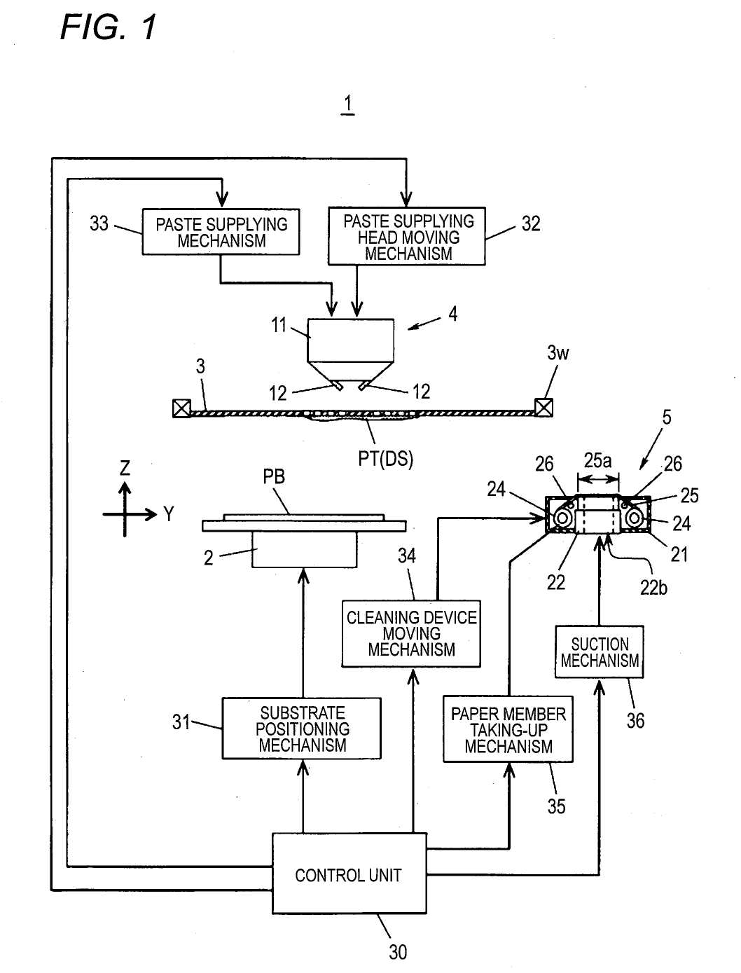

Hereafter, a description will be given of an embodiment of the present invention with reference to the drawings. In FIG. 1, a screen printing machine 1 in accordance with this embodiment is comprised of a substrate holding portion 2 for holding a substrate PB which is an object to be printed on; a screen printing mask (hereafter, simply referred to as the mask) 3 of a rectangular shape provided horizontally over the substrate PB held by the substrate holding portion 2; a paste supplying head 4 provided over the mask 3; and a cleaning device 5 for effecting the cleaning of the mask 3 by coming into contact with the lower surface of the mask 3 from below after execution of screen printing by the screen printing machine 1. Hereafter, it is assumed for the sake of explanation that a direction perpendicular to the plane of the drawing of FIG. 1 is an X-axis direction, that a left-right direction in the plane of the drawing of FIG. 1 is a Y-axis direction, and that a vertical direction in the plane of the drawing of FIG. 1 is a Z-axis direction.

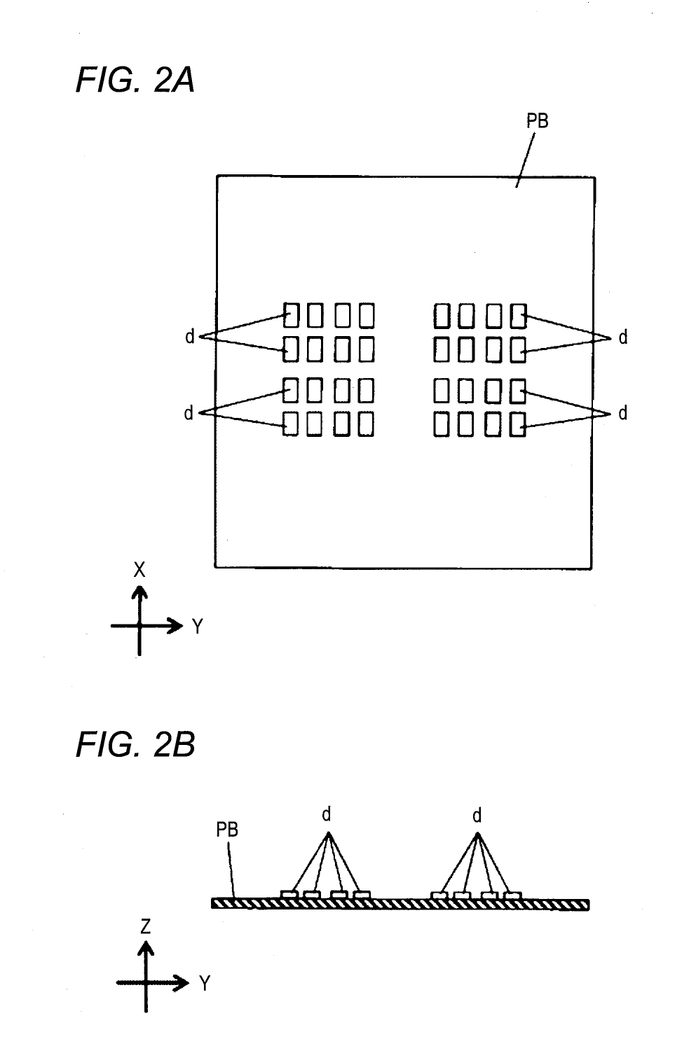

A plurality of electrodes d are provided on the upper surface of the substrate PB in FIGS. 2A and 2B. The substrate holding portion 2 is provided movably in a direction within the horizontal plane (direction within the X-Y plane) and in a vertical direction (Z-axis direction), and thereby allows the held substrate PB to be positioned at an arbitrary position below the mask 3.

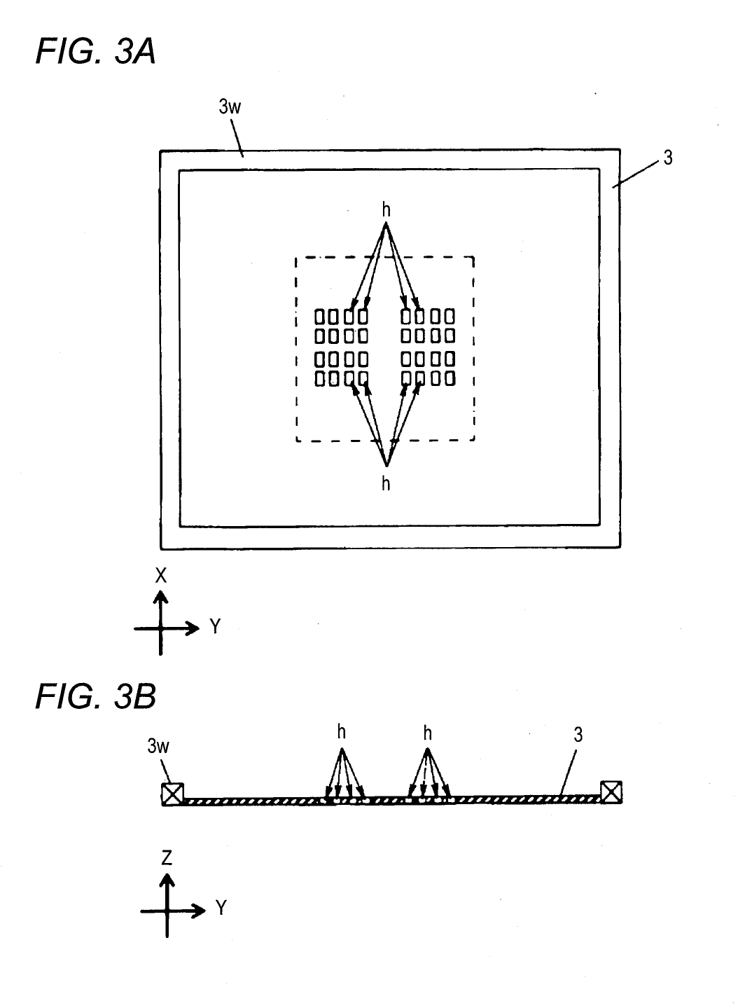

In FIGS. 1, 3A, and 3B, the mask 3 is supported at its four sides by a frame member 3w, and a plurality of pattern holes h corresponding to the plurality of electrodes d provided on the upper surface of the substrate PB are provided in its rectangular area surrounded by the frame member 3w.

In FIG. 1, the paste supplying head 4 is constituted by including a head body 11 provided movably in a direction within the horizontal plane (direction within the X-Y plane) and in the vertical direction (Z-axis direction) with respect to the mask 3, and two guide members 12 provided on a lower portion of the head body 11 and opposing each other in the Y-axis direction. Each guide member 12 is a spatula-like member extending in the X-axis direction and serves as a guide for allowing paste such as solder paste or electrically conductive paste, which is supplied (press fed) downward by a paste cartridge (not shown) incorporated in the head body 11, to be supplied in a concentrated manner to a target position on the mask 3.

The cleaning device 5 includes a case-like base portion 21 provided movably in a direction within the horizontal plane (direction within the X-Y plane) and in the vertical direction (Z-axis direction); a backup member 22 provided in the base portion 21 and having an upwardly open, rectangular frame-shaped nozzle portion 22a; elastic members 23 provided in such a manner as to surround an outer periphery of an upper end portion (nozzle portion 22a) of the backup member 22; a pair of takeup rollers 24 which are disposed in face-to-face relation in the Y-axis direction with the backup member 22 interposed therebetween and are rotatable in the X-axis direction; a paper member 25 trained between the pair of takeup rollers 24; and a pair of guide rollers 26 disposed between the pair of takeup rollers 24 in face-to-face relation in the Y-axis direction with the backup member 22 interposed therebetween and are rotatable in the X-axis direction.

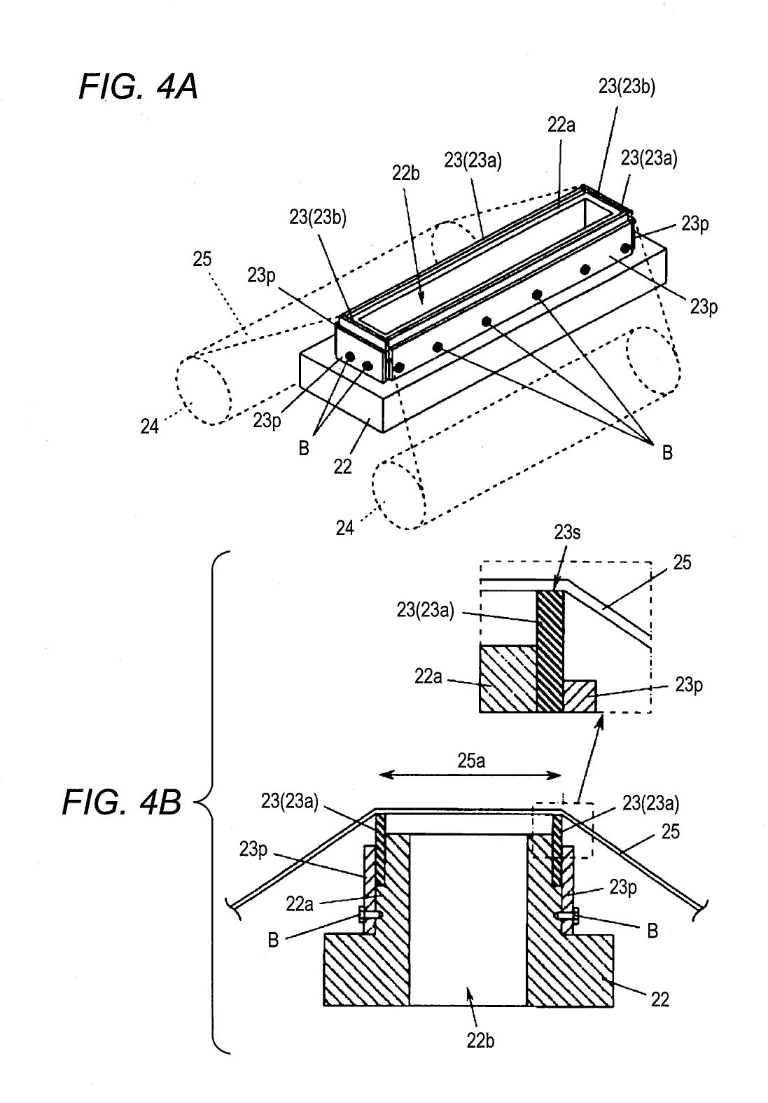

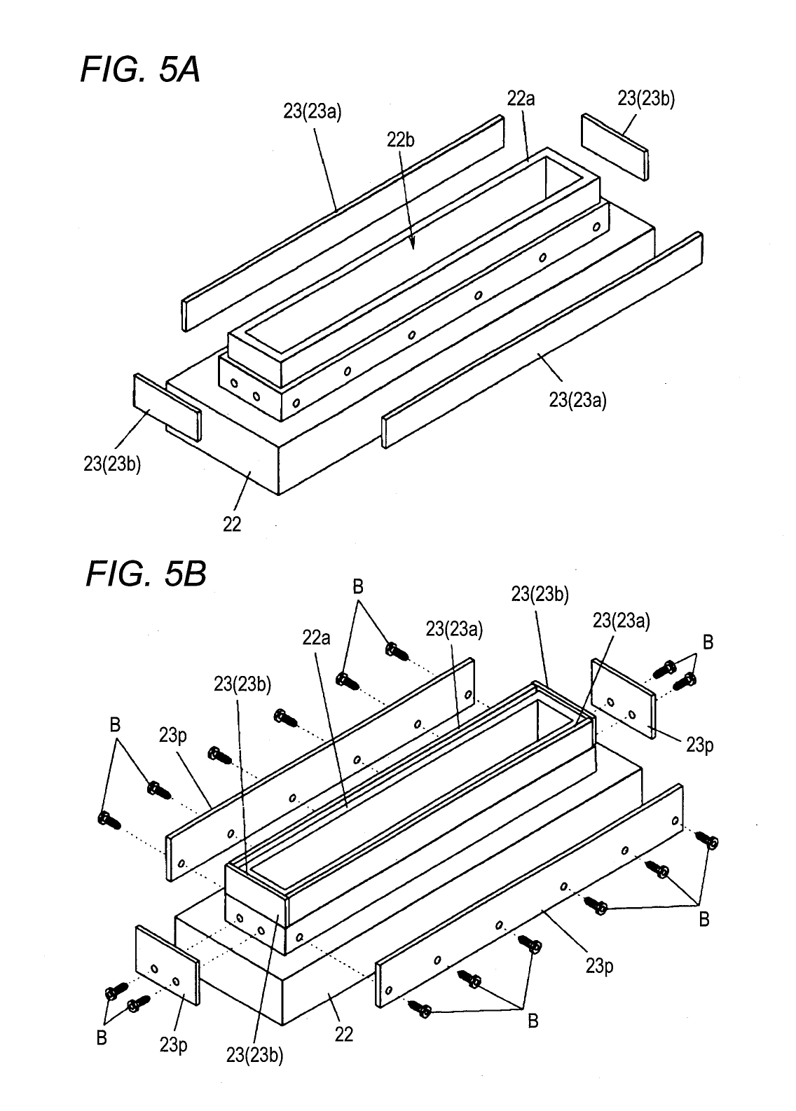

In FIGS. 4A, 4B, 5A, and 5B, the elastic members 23 are constituted by a pair of elastic members 23a provided along long side portions of the nozzle portion 22a of the backup member 22 and a pair of elastic members 23b provided along short side portions of the nozzle portion 22a. These four elastic members 23 are fitted to outer peripheral surfaces of the nozzle portion 22a by being pressed by plate-like pressing members 23p which are respectively attached to side surfaces of the nozzle portion 22a by a plurality of fastening tools B. Adjacent ones of the elastic members 23 have their ends in contact or proximity with each other, and the four elastic members 23 as a whole have a closed shape (a closed frame shape as viewed from the top).

The upper surface of the paper member 25 is formed as an adhesive surface, and its horizontal area supported by the four elastic members 23 between the pair of guide rollers 26 is formed as a rubbing area 25a for rubbing the lower surface of the mask member 3 from below. The upper surface of each elastic member 23, which serves as a contact surface 23s (see the enlarged view in FIG. 4B) with the paper member 25, is formed as a horizontal flat surface, so that each elastic member 23 is arranged to be able to come into surface contact with the paper member 25.

The rubbing area 25a of the paper member 25 can be renewed as the paper member 25 is taken up by driving the pair of takeup rollers 24 in the same direction. In addition, in FIG. 4B, a vertically penetrating air suction duct 22b is provided in the backup member 22, so that the arrangement provided is such that as vacuum pressure is supplied into this air suction duct 22b, air can be sucked from the interior of the air suction duct 22b through the rubbing area 25a of the paper member 25.

The positioning operation of the substrate PB with respect to the mask 3 on the basis of the movement of the substrate holding portion 2 in the direction within the horizontal plane and in the vertical direction is effected as a control unit 30 (FIG. 1) provided in this screen printing machine 1 performs operational control of a substrate positioning mechanism 31 (FIG. 1) constituted by an unillustrated actuator and the like.

The positioning operation of the paste supplying head 4 with respect to the mask 3 on the basis of the movement of the head body 11 of the paste supplying head 4 in the direction within the horizontal plane and in the vertical direction is effected as the control unit 30 performs operational control of a paste supplying head moving mechanism 32 (FIG. 1) constituted by an unillustrated actuator and the like. The supplying operation of paste from the paste supplying head 4 is effected as the control unit 30 performs operational control of a paste supplying mechanism 33 (FIG. 1) constituted by an unillustrated actuator and the like.

The positioning and relatively moving operation of the cleaning device 5 with respect to the mask 3 on the basis of the movement of the base portion 21 of the cleaning device 5 in the direction within the horizontal plane and in the vertical direction is effected as the control unit 30 performs operational control of a cleaning device moving mechanism 34 (FIG. 1) constituted by an unillustrated actuator and the like. In addition, the taking-up operation of the paper member 25 (the renewing operation of the rubbing area 25a of the paper member 25) by the pair of takeup rollers 24 is effected as the control unit 30 performs operational control of a paper member taking-up mechanism 35 (FIG. 1) constituted by an unillustrated actuator and the like. In addition, the air sucking operation through the rubbing area 25a of the paper member 25, which is effected by supplying vacuum pressure into the air suction duct 22b, is effected as the control unit 30 performs operational control of a suction mechanism 36 constituted by an unillustrated actuator and the like.

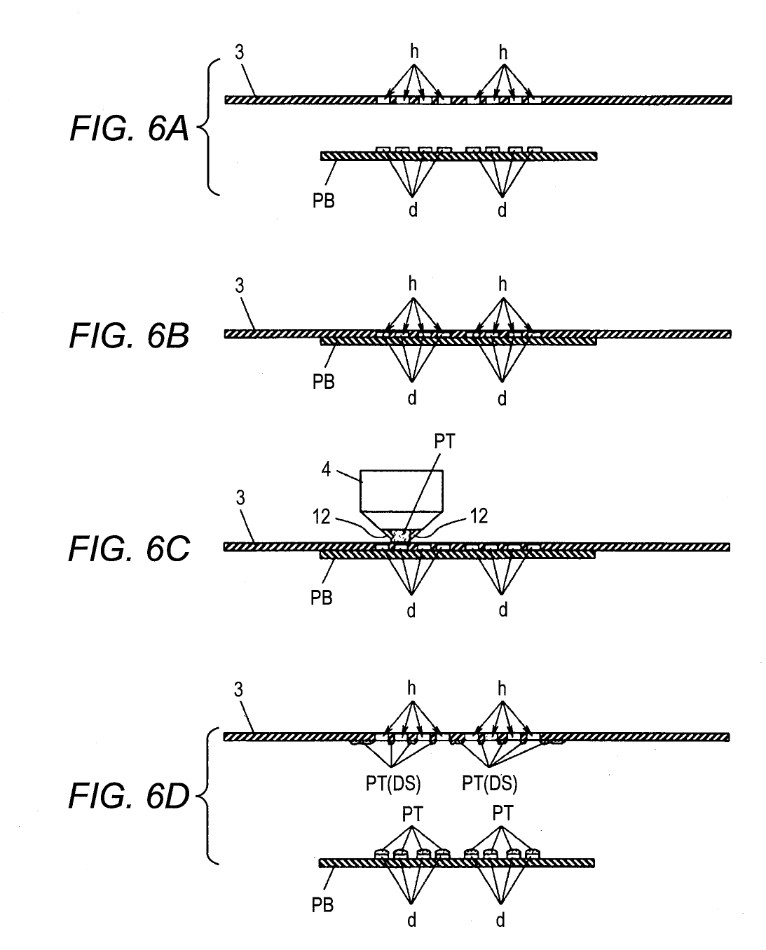

In the execution step of screen printing onto the substrate PB by this screen printing machine 1, the control unit 30 first moves the substrate PB such that the pattern holes h in the mask 3 and the electrodes d on the substrate PB held by the substrate holding portion 2 correspond to each other vertically (FIG. 6A), and subsequently raises the substrate PB such that the upper surface of the substrate PB and the lower surface of the mask 3 come into contact with each other (FIG. 6B). In consequence, the pattern holes h in the mask 3 and the electrodes d on the substrate PB correspond to each other vertically (positioning step).

After the upper surface of the substrate PB and the lower surface of the mask 3 are brought into contact with each other, the control unit 30 causes the guide members 12 of the paste supplying head 4 to be brought into contact with the upper surface of the mask 3 and actuates the paste supplying mechanism 33 to thereby supply paste PT onto the upper surface of the substrate PB (FIG. 6C, paste supplying step). In consequence, since the paste PT is supplied onto the electrodes d through the pattern holes h in the mask 3, if the substrate PB and the mask 3 are subsequently relatively moved away from each other vertically (releasing step), the paste PT is printed (transferred) onto the electrodes d (FIG. 6D).

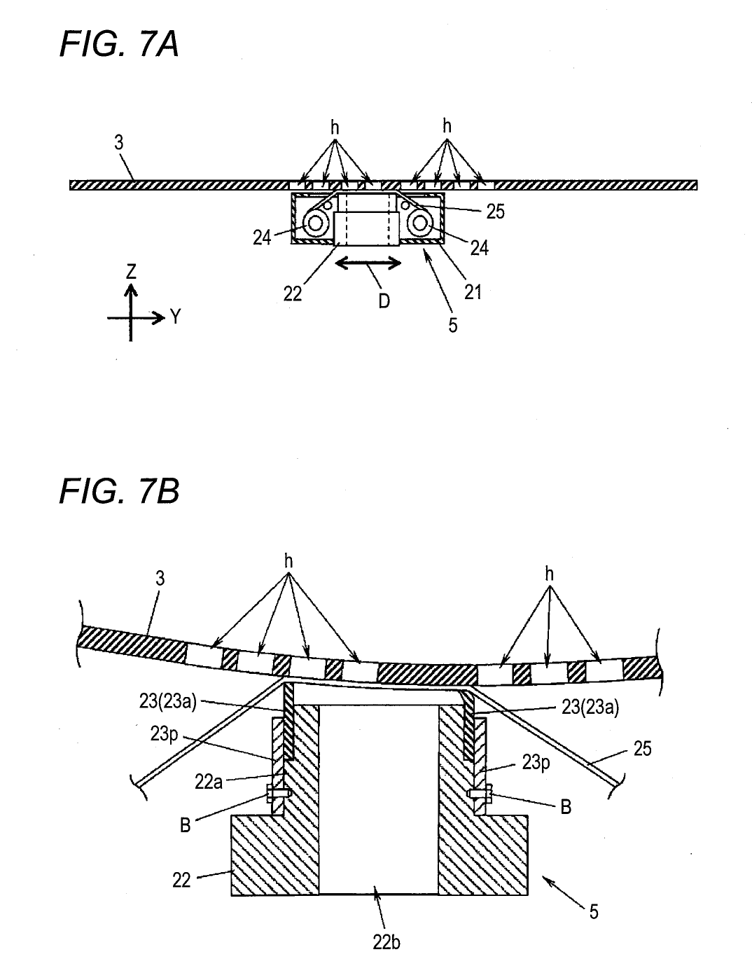

Upon completion of the above-described screen printing execution process, the control unit 30 effects the cleaning of the lower surface of the mask 3 by the cleaning device 5. In the cleaning of the lower surface of the mask 3, as shown in FIG. 7A, the control unit 30 carries out operational control of the cleaning device moving mechanism 34 to bring the rubbing area 25a of the paper member 25 into contact with the lower surface of the mask 3 and then to move the base portion 21 in the direction within the horizontal plane (here in the Y-axis direction) (arrow D shown in FIG. 7A). In consequence, the paste PT (residue DS of the paste PT, see FIG. 6D) adhering to the lower surface of the mask 3 sticks to the rubbing area 25a of the paper member 25, so that the paste PT can be wiped off the lower surface of the mask 3 (paste wiping-off step).

In this paste wiping-off step, although the rubbing area 25a of the paper member 25 is pressed against the lower surface of the mask 3 via the elastic members 23 provided on the upper end portion of the backup member 22, the elastic members 23 undergo elastic deformation so as to follow the shape of the mask 3 and press the paper member 25 against the lower surface of the mask 3. Therefore, as shown in FIG. 7B, the mask 3 is deflected downward by its own weight and assumes a convex shape, so that, even with the mask 3 whose lower surface no longer has a flat shape, the paper member 25 can be brought into close contact with its lower surface, allowing the wiping off of the paste PT to be effected efficiently. In addition, since the upper surface of each elastic member 23, i.e., the contact surface 23s with the paper member 25, is formed as a flat surface, the paper member 25 can be pressed against to rub the mask 3 with a wide area, allowing the wiping off of the paste PT to be effected efficiently. In addition, since the elastic members 23 are provided so as to surround the outer periphery of the upper end portion (nozzle portion 22a) of the backup member 22, the contact area between the paper member 25 and the lower surface of the mask 3 increases correspondingly, which also contributes to the pressing of the paper member 25 against the mask 3 with a wide area.

In addition, at the time of the wiping off of the paste PT in the above-described paste wiping-off step, the control unit 30 performs the operational control of the suction mechanism 36 to evacuate the air suction duct 22b via the rubbing area 25a of the paper member 25. In consequence, the paste PT adhering to the lower surface of the mask 3 is sucked to the paper member 25 side, so that the wiping off of the paste PT can be carried out more effectively. Here, since the elastic members 23 are provided so as to surround the outer periphery of the upper end portion (nozzle portion 22a) of the backup member 22, the sucking out of the paste PT can be performed by setting in a hermetically closed state that area of the lower surface of the mask 3 which is subject to the sucking out of the paste PT.

When the amount of the residue DS of the paste PT adhering to the rubbing area 25a of the paper member 25 has become large, the control unit 30 operates the paper member taking-up mechanism 35 to perform the taking up of the paper member 25, and thereby renews the rubbing area 25a of the paper member 25.

It should be noted that, among the substrates 3, there is known a type (so-called cavity substrate) in which electrodes are provided not only on its upper surface but also on a bottom of an opening (cavity portion) recessed from the upper surface. In the case of a mask corresponding to such a cavity substrate, a convexly shaped portion with a shape fitting to the cavity portion is formed on its lower surface, so that a problem occurs in the efficiency of wiping off the paste PT as with the case where the mask 3 is deflected downward by its own weight and assumes a convex shape. However, according to the cleaning device 5 in accordance with this embodiment, since the elastic members 23 attached to the upper end portion of the backup member 22 undergo elastic deformation and thereby conform to the convexly shaped portion formed on the lower surface of the mask 3, also with respect to the mask corresponding to the cavity substrate, the paste PT can be wiped off efficiently from its lower surface in the same way as the mask 3 which assumes a downwardly convex shape due to its own weight.

As described above, the cleaning device 5 for the screen printing mask 3 in accordance with this embodiment is comprised of the paper member 25 for rubbing the lower surface of the mask 3; the backup member 22 for pressing the paper member 25 against the lower surface of the mask 3 via the elastic members 23 attached to the upper end portion thereof; and a paper member rubbing device (the cleaning device moving mechanism 34 and the control unit 30) for effecting the wiping off of the paste PT adhering to the lower surface of the mask 3 by rubbing the lower surface of the mask 3 with the paper member 25 by relatively moving with respect to the mask 3 the backup member 22 with the paper member 25 pressed against the lower surface of the mask 3 via the elastic members 23.

Thus, in this embodiment, the arrangement provided is such that the paper member 25 is pressed against the lower surface of the mask 3 via the elastic members 23 provided on the upper end portion of the backup member 22. Since the elastic members 23 can be made to follow the shape of the mask 3 by undergoing elastic deformation, even with the mask 3 whose lower surface does not have a flat shape, the paper member 25 can be brought into close contact with its lower surface, allowing the wiping off of the paste PT to be carried out efficiently.

In addition, in cases where, as in this embodiment, the paste PT adhering to the lower surface of the mask 3 is adapted to be sucked out to the paper member 25 side by sucking air through the rubbing area 25a of the paper member 25 from the air suction duct 22b provided inside the backup member 22, the paper member 25 can be brought into close contact with the lower surface of the mask 3. Therefore, the amount of air leakage during the suction of air becomes small, and it is hence possible to improve the effect of sucking out the paste PT, so that the efficiency of wiring off the paste PT can be improved in this aspect as well.

In addition, with the cleaning device 5 in accordance with this embodiment, since the upper surfaces of the elastic members 23, i.e., the contact surfaces 23s with the paper member 25, are formed as flat surfaces, the paper member 25 can be pressed against to rub the mask 3 with a wide area, thereby making it possible to improve the efficiency of wiping off the paste PT correspondingly.

In addition, since the elastic members 23 are provided so as to surround the outer periphery of the upper end portion (nozzle portion 22a) of the backup member 22, not only can the contact area between the paper member 25 and the lower surface of the mask 3 be increased, but the sucking out of the paste PT can be performed by setting in a hermetically closed state that area of the lower surface of the mask 3 which is subject to the sucking out of the paste PT. Therefore, it is possible to further improve the efficiency of wiping off the paste PT.

In addition, the screen printing machine 1 in accordance with this embodiment is comprised of the mask 3 which is used by coming into contact with the substrate PB and in which the pattern holes h corresponding to the electrodes d on the substrate PB are formed; printing execution means (the paste supplying head 4, the substrate holding portion 2, the paste supplying mechanism 33, the substrate positioning mechanism 31, and the control unit 30) for printing the paste PT on the electrodes d by supplying the paste PT onto the mask 3 in a state in which the pattern holes h formed in the mask 3 and the electrodes d on the substrate PB correspond to each other, and subsequently by relatively moving the mask 3 and the substrate PB away from each other; and the above-described cleaning device 5 for effecting the wiping off of the paste PT adhering to the lower surface of the mask 3. With such a screen printing machine 1, since the cleaning device 5 capable of effecting the wiping off of the paste PT efficiently is provided, it is possible to shorten the time required for cleaning the mask 3, thereby making it possible to improve the productivity of the substrates PB.

Although a description has heretofore been given of the embodiment of the present invention, the present invention is not limited to the one shown in the above-described embodiment. For example, although, in the above-described embodiment, the elastic members 23 provided so as to surround the outer periphery of the upper end portion (nozzle portion 22a) of the backup member 22 are constituted by a plurality of members (the pair of elastic members 23a provided along long side portions of the nozzle portion 22a and the pair of elastic members 23b provided along short side portions of the nozzle portion 22a), this is one example, and it is possible to adopt, for instance, a construction in which a single elastic member 23 having a cross-sectional shape which forms a close frame shape is attached to the backup member 22 by being fitted thereto from above.

According to the present invention, it is possible to provide a cleaning device for a screen printing mask and a screen printing machine which are capable of efficiently effecting the wiping off of paste with respect to the screen printing mask whose lower surface does not have a flat shape.

What is claimed is:

1. A cleaning device for a screen printing mask for effecting a wiping off of paste adhering to a lower surface of the screen printing mask, comprising:
a paper member for rubbing a lower surface of the screen printing mask;
a backup member for pressing the paper member against the lower surface of the screen printing mask via an elastic member attached to an upper end portion thereof; and
a paper member rubbing device for effecting a wiping off of the paste adhering to the lower surface of the screen printing mask by rubbing the lower surface of the screen printing mask with the paper member by relatively moving with respect to the screen printing mask the backup member with the paper member pressed against the lower surface of the screen printing mask via the elastic member.

2. The cleaning device for a screen printing mask according to claim 1, wherein the elastic member attached to the upper end portion of the backup member is provided so as to surround an outer periphery of the upper end portion of the backup member.

3. The cleaning device for a screen printing mask according to claim 1 or 2, wherein the elastic member attached to the upper end portion of the backup member has a flatly formed surface of contact with the paper member.

4. A screen printing machine for effecting screen printing on electrodes provided on a substrate, comprising:
a screen printing mask which is used by coming into contact with the substrate and in which pattern holes corresponding to the electrodes on the substrate are formed;
printing execution means for printing paste on the electrodes by supplying the paste onto the screen printing mask in a state in which the pattern holes formed in the screen printing mask and the electrodes on the substrate correspond to each other, and subsequently by relatively moving the screen printing mask and the substrate away from each other; and
a cleaning device for the screen printing mask for effecting the wiping off of the paste adhering to the lower surface of the screen printing mask, the cleaning device for the screen printing mask including:
a paper member for rubbing the lower surface of the screen printing mask;
a backup member for pressing the paper member against the lower surface of the screen printing mask via an elastic member attached to an upper end portion thereof; and
a paper member rubbing device for effecting the wiping off of the paste adhering to the lower surface of the screen printing mask by rubbing the lower surface of the screen printing mask with the paper member by relatively moving with respect to the screen printing mask the backup member with the paper member pressed against the lower surface of the screen printing mask via the elastic member.
